(19) United States
(12) Patent Application Publication
(10) Pub. No.: US 2023/0056220 A1
(43) Pub. Date: Feb. 23, 2023

(54) SYSTEM AND METHOD FOR PRINTING WITH IMPROVED CONTENT

(71) Applicant: Toshiba TEC Kabushiki Kaisha, Shinagawa-ku (JP)

(72) Inventor: William SU, Riverside, CA (US)

(21) Appl. No.: 17/407,427

(22) Filed: Aug. 20, 2021

(51) Int. Cl. G06F 40/205; G06F 16/9536; G06F 40/106; G06F 16/2457

(52) U.S. Cl. CPC G06F 40/205; G06F 16/9536; G06F 40/106; G06F 16/24575

(57) ABSTRACT

A system and method for printing with improved content builds an analytics dataset of big data built from content retrieved from an array of networked servers. When a user scans or prints their document, a print file or a scan file is analyzed for content and applied to the analytics dataset. Characteristics of the user are determined, and suggestions for modification, including additions, corrections, deletions or substitutions are rendered to the user upon printing. Additions may be automatically rewritten or rephrased to avoid direct use of content of others.

### TECHNICAL FIELD

This application relates generally to printing. The application relates more particularly to use of big data to extract human characteristics of a user-generated print file and recommend additional content associated with the big data.

### BACKGROUND

Document processing devices include printers, copiers, scanners and e-mail gateways. More recently, devices employing two or more of these functions are found in office environments. These devices are referred to as multifunction peripherals (MFPs) or multifunction devices (MFDs). As used herein, MFPs are understood to comprise printers, alone or in combination with other of the afore-noted functions. It is further understood that any suitable document processing device can be used.

Authors of electronic print content will send their print files to an MFP which prints the document to display the content as it was received.

### BRIEF DESCRIPTION OF THE DRAWINGS

Various embodiments will become better understood with regard to the following description, appended claims and accompanying drawings wherein:

FIG. 1 is an example embodiment of a system for printing with improved content;

FIG. 2 is an example embodiment of a networked digital device, such as multifunction peripheral;

FIG. 3 is an example embodiment of a digital data processing device;

FIG. 4 is as system overview of an example embodiment of a system for printing with improved content;

FIG. 5 is a hardware module block diagram of an example embodiment of a system for printing with improved content;

FIG. 6 is a software module block diagram of an example embodiment of a system for printing with improved content; and

FIG. 7 is a flowchart of an example embodiment of a system for printing with improved content.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

A relational database is a type of database that stores and provides access to data points that are related to one another. Relational databases are based on the relational model, an intuitive, straightforward way of representing data in tables. In a relational database, each row in the table is a record with a unique ID called the key. The columns of the table hold attributes of the data, and each record usually has a value for each attribute, making it easy to establish the relationships among data points.

A relational database organizes data into tables which can be linked, or related, based on data common to each. This capability enables one to retrieve an entirely new table from data in one or more tables with a single query.

Relational databases are comprised of columns and rows. A column is a set of data values of a particular type, one value for each row of the database. A column may contain text values, numbers, or pointers to files in an operating system. Columns may comprise simple or more complex data types, such as whole documents, images, or multimedia, such as sound or video clips. A column can also be called an attribute. Each row provides a data value for each column and forms a single structured data value. For example, a database that represents company contact information might have the following columns: ID, Company Name, Address Line 1, Address Line 2, City, and Postal Code. More formally, a row is a tuple containing a specific value for each column, for example: (1234, ‘Big Company Inc.’, ‘123 East Example Street’, ‘456 West Example Drive’, ‘Big City’, 98765). The word ‘field’ is normally used interchangeably with ‘column’.

Big data uses relational databases to analyze, systematically extract information from, or otherwise deal with data sets that are too large or complex to be dealt with by traditional data-processing application software. Data with many fields or columns offer greater statistical power, while data with higher complexity (more attributes or columns) may lead to a higher false discovery rate. Big data analysis challenges include capturing data, data storage, data analysis, search, sharing, transfer, visualization, querying, updating, information privacy, and data source.

Big data can use predictive analytics, user behavior analytics or any suitable data analytics method to extract value from big data.

Relational database management systems and desktop statistical software packages used to visualize data often have difficulty processing and analyzing big data. Processing and analysis of big data may require software running in multiple servers.

As used herein Big Data is an analytics dataset comprised of information that users are continuously generating both online and offline. Big Data targets understanding of MFP users. It includes what users have scanned or printed, and may also include such information as their age, gender, occupation, location, travel history, social media activity or favorite articles.

By way of example, one may wish to create a marketing strategy for potential investors. This can lead a company improved profitability. The challenge is how to create better content to deliver improved results. A team of talented writers and designers may increase a likelihood of success, but this may not be optimal. Sometimes a single precisely targeted word can make the difference between a good marketing strategy and a better, or best, marketing strategy, increasing the probability that the strategy will be effective against your competitors.

In example embodiment herein, a user has already written a document and wants to print it. During the print submission process, the system will use Big Data, search for better content and provide the user with suggestions to modify the document before printing.

Information can be used, such as how many similar articles people find. Thousands of new posts are published every day. Many of these posts many provide content that people like. If an article contains a lot of meaningful content and most people like it, the system will improve its ranking and suggest that content to users. The system can learn and adapt to new data without human intervention. A user will typically write a document using text or characters. Here are some examples wherein recommended content, such as additional or corrected information, is generated from extracted text from a print file.

### EXAMPLE #1

Text: “Michael Jeffrey Jordan was born on Feb. 17, 1964”

Issue: Incorrect information.

Recommendation: Michael Jeffrey Jordan was born on Feb. 17, 1963

### EXAMPLE #2

Text: “In his article Stanley Fish shows that we don't really have the right to free speech.”

Issue: A thesis takes a position on an issue.

Recommendation: Stanley Fish's argument that free speech exists more as a political prize than as a legal reality ignores the fact that even as a political prize it still serves the social end of creating a general cultural atmosphere of tolerance that may ultimately promote free speech in our nation just as effectively as any binding law.

### EXAMPLE #3

Text: “The government has the right to limit free speech.”

Issue: A thesis should be as specific as possible, and it should be tailored to reflect the scope of the paper.

Recommendation: The government has the right to limit free speech in cases of overtly racist or sexist language because our failure to address such abuses would effectively suggest that our society condones such ignorant and hateful views.

### EXAMPLE #4

Text: “Although we have the right to say what we want, we should avoid hurting other people's feelings.”

Issue: A thesis must be arguable.

Recommendation: If we can accept that emotional injuries can be just as painful as physical ones we should limit speech that may hurt people's feelings in ways similar to the way we limit speech that may lead directly to bodily harm.

### EXAMPLE #5

Text: “There are many reasons we need to limit hate speech.”

Issue: A good argumentative thesis provides not only a position on an issue, but also suggests the structure of the paper.

Recommendation: Among the many reasons we need to limit hate speech the most compelling ones all refer to our history of discrimination and prejudice, and it is, ultimately, for the purpose of trying to repair our troubled racial society that we need hate speech legislation.

### EXAMPLE #6

Text: “Hate speech can cause emotional pain and suffering in victims just as intense as physical battery.”

Issue: a thesis statement that makes a factual claim that can be verified only with scientific, sociological, psychological, or other kind of experimental evidence is not appropriate.

Recommendation: The various arguments against the regulation of hate speech depend on the unspoken and unexamined assumption that emotional pain is either trivial.

Accordingly, when users print a document, they receive recommendations about similar and better content that may be of interest to them. This can be achieved, for example, by a system that considers an audience's demographics or observed behavior. After the system has found information that fits the user's document, the system rewrites or rephrases it serving to alleviate plagiarism. Reference a page or pages of works relied upon are suitably cited at the end of any document. The system continuously invests effort to understand the users, supply them with meaningful content and then measure a success of recommendation and determine which content performs better from the rest. This may further include information as to whether the user ultimately adopts some or all of suggested modified content in their ultimate printout.

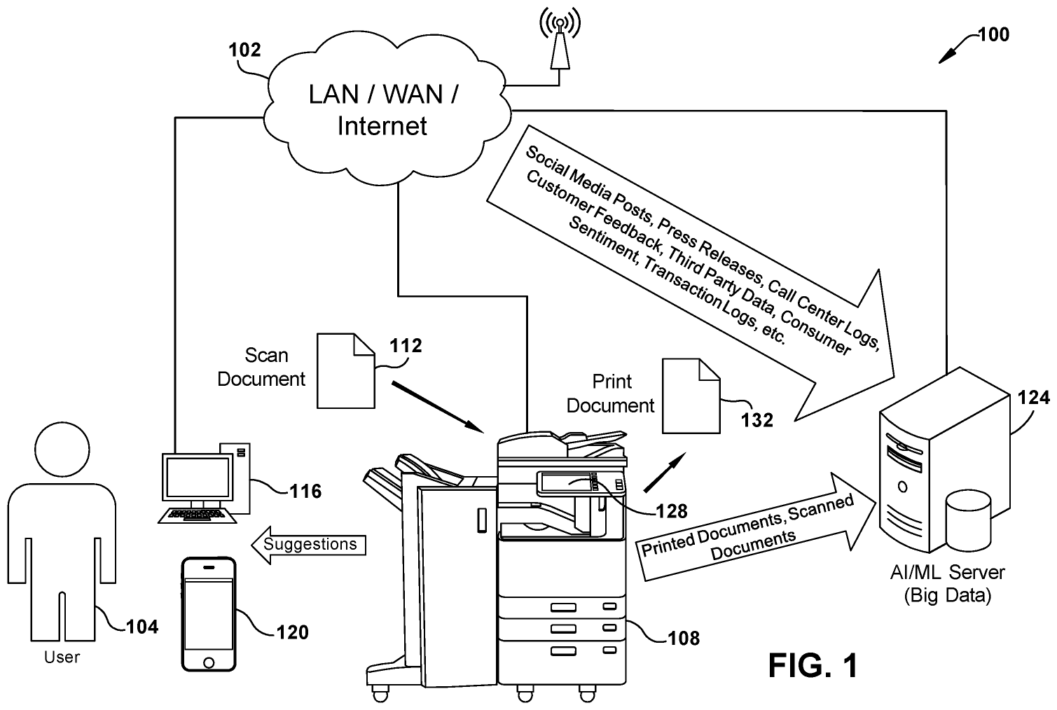

FIG. 1 illustrates an example embodiment of a system 100 for printing with improved content. Devices in FIG. 1 are in data communication via network cloud 102, suitably comprised of a local area network (LAN), a wide area network (WAN), which may comprise the Internet, or any suitable combination thereof. Network cloud is comprised of any suitable wireless or wired data connection or combination thereof.

In the illustrated example, a user 104 wishes to scan or print a document on MFP 108. Scanning of scan document 112 generates a scan file which may be subject to optical character recognition. The user may also send a print job by uploading it to MFP 108 directly, or via a digital user device such as workstation 116 or smartphone 120. A print file or scan file is sent to an artificial intelligence/machine learning server 124 via network cloud 102. Server 124 is provided with Big Data on any suitable platform. Machine learning or artificial intelligence applications can be implemented on any suitable platform such as Microsoft's AZURE. Alternatives, by way of example, include platforms INZATA, ANSWEROCKET, SEEBO, and others.

Server 124 secures Big Data from sources such as Internet sources including social media posts, press releases, call center logs, customer feedback, third party data, consumer sentiment information, transaction logs, or the like. Big Data is also sourced from MFP information, including content of print files and scan files. Server 124 applies Big Data to a received print file or scan file, and determines human characteristics of an author of the print file. Server 124 then outputs suggestions for modification of the original document, including corrections, additions or deletions which are relayed to user 104 such as by display on MFP touchscreen 128 of MFP 108, on workstation 116 or smartphone 120. Suggestions may also be added to the user's electronic document so as to be displayed in context. Such suggestions may be also be viewed by printing the suggestions or the annotated document. As noted above, source are suitably included in the annotations or as an attachment.

User 104 is provided with an ability to accept, reject or modify any generated suggestions. Once finalized, the final document is again sent to server 124 for further analysis and refinement of Big Data in accordance with user input. Modified document 132 is then printed. Accordingly, a user need only send a file for printing and the system works from there.

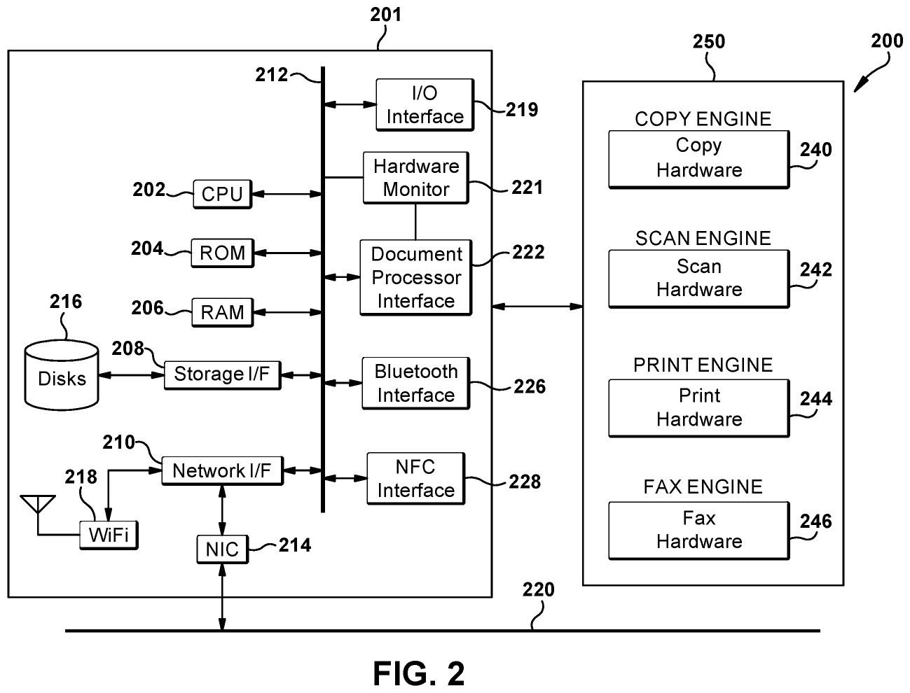

Turning now to FIG. 2, illustrated is an example embodiment of a networked digital device comprised of document rendering system 200 suitably comprised within an MFP, such as with MFPs 108 of FIG. 1. It will be appreciated that an MFP includes an intelligent controller 201 which is itself a computer system. Thus, an MFP can itself function as a server with the capabilities described herein. Included in intelligent controller 201 are one or more processors, such as that illustrated by processor (CPU) 202. Each processor is suitably associated with non-volatile memory, such as read-only memory (ROM) 204, and random access memory (RAM) 206, via a data bus 212.

Processor 202 is also in data communication with a storage interface 208 for reading or writing to a storage 216, suitably comprised of a hard disk, optical disk, solid-state disk, cloud-based storage, or any other suitable data storage as will be appreciated by one of ordinary skill in the art.

Processor 202 is also in data communication with a network interface 210 which provides an interface to a network interface controller (NIC) 214, which in turn provides a data path to any suitable wired interface or physical network connection 220, or to a wireless data connection via wireless network interface 218. Example wireless data connections include cellular, Wi-Fi, Bluetooth, NFC, wireless universal serial bus (wireless USB), satellite, and the like. Example wired interfaces include Ethernet, USB, IEEE 1394 (FireWire), Lightning, telephone line, or the like.

Processor 202 can also be in data communication with any suitable user input/output (I/O) interface 219 which provides data communication for interfacing with user peripherals, such as displays, keyboards, mice, track balls, touch screens, or the like. Processor 202 can also be in communication with hardware monitor 221, such as a page counter, temperature sensor, toner or ink level sensor, paper level sensor, or the like.

Also in data communication with data bus 212 is a document processor interface 222 suitable for data communication with the document rendering system 200, including MFP functional units. In the illustrated example, these units include copy hardware 240, scan hardware 242, print hardware 244 and fax hardware 246 which together comprise MFP functional hardware 250. It will be understood that functional units are suitably comprised of intelligent units, including any suitable hardware or software platform.

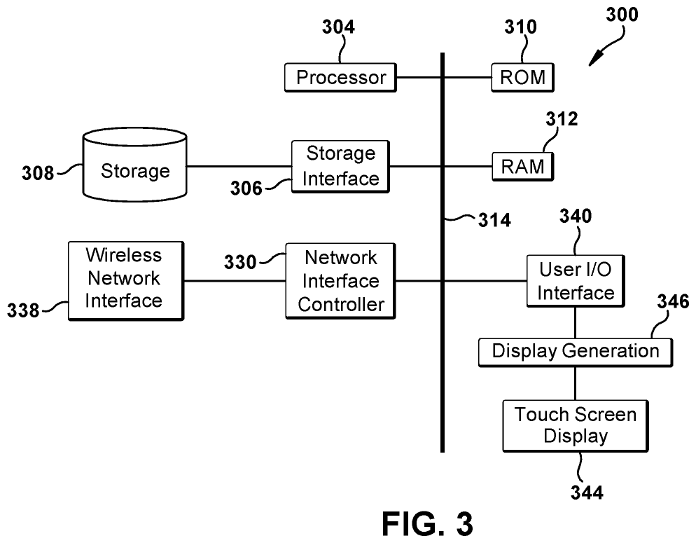

Turning now to FIG. 3, illustrated is an example embodiment of a digital data processing device 300 such as workstation 116, smartphone 120 or server 124 of FIG. 1. Components of the digital data processing device 300 suitably include one or more processors, illustrated by processor 304, memory, suitably comprised of read-only memory 310 and random access memory 312, and bulk or other non-volatile storage 308, suitably connected via a storage interface 306. A network interface controller 330 suitably provides a gateway for data communication with other devices, such as via wireless network interface 338. A user input/output interface 340 suitably provides display generation 346 providing a user interface via touchscreen display 344, suitably displaying images from display generator 346. It will be understood that the computational platform to realize the system as detailed further below is suitably implemented on any or all of devices as described above.

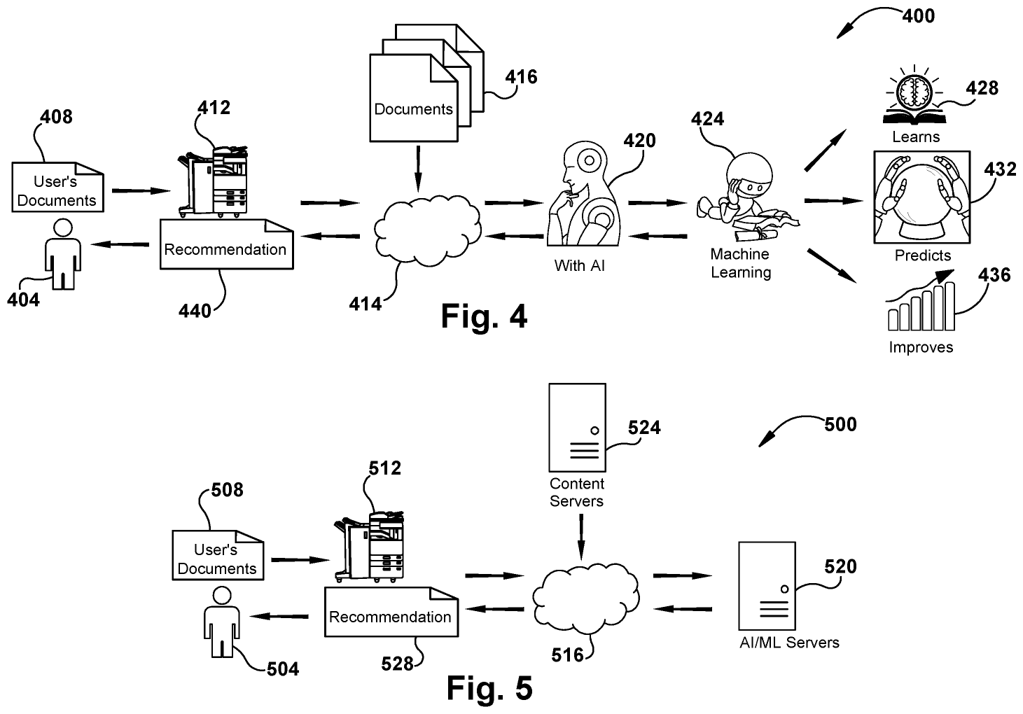

FIG. 4 illustrates as system overview 400 of an example embodiment of a system for printing with improved content. User 404 submits documents 408, suitably tangible or electronic, to MFP 412 for printing. MFP 412 sends the user's documents through network cloud 414 to one or more servers for processing. Also sent to the one or more servers is additional network content, illustrated by electronic documents 416. Information received via network cloud 414 is subject to artificial intelligence processing 420 and machine learning 424 which cooperatively learns 428, predicts 432 and improves 436, resulting in recommendations 440 communicated to user 404 in tangible or intangible form.

FIG. 5 illustrates a hardware module block diagram 500 of an example embodiment of a system for printing with improved content. User 504 submits documents 508, in electronic or tangible form, to MFP 512. MFP 512 sends the user's documents through network cloud 516 to one or more artificial intelligence/machine learning servers, illustrated by server 520. Server 520 received additional content from networked servers, such as Internet server 524. Examples of Internet content include social media posts, online resources, such as dictionaries, encyclopedias, thesauruses, audio/video content sites, document repositories, translation resources, entertainment sites, or the like. Server 520 uses all data received via network cloud 516 to generate recommendations 528 which are shown to user 504 in electronic or tangible form, and may comprise an annotated version of user documents 508.

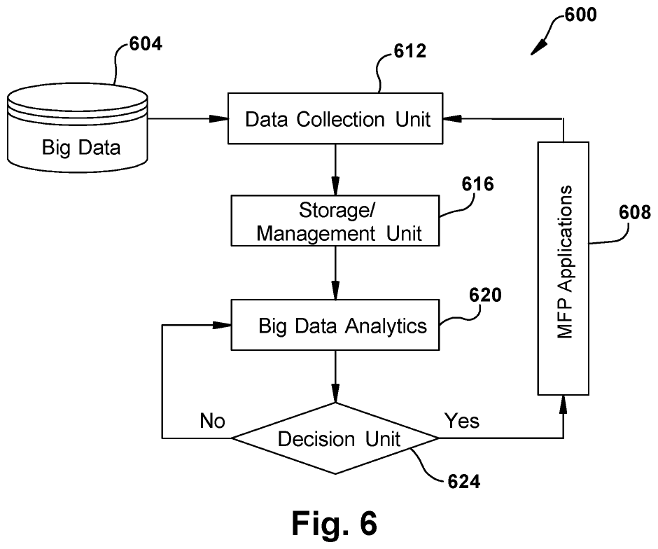

FIG. 6 illustrates a software module block diagram 600 of an example embodiment of a system for printing with improved content. Big Data 604 and user documents received from MFP application 608 are received by data collection unit 612 and provided to storage/management unit 616. Big Data analytics are performed by unit 620 and supplied to decision unit 624. Big Data analytics continue until such time as decision unit determines that there are satisfactory suggestions. Satisfactory suggestions are relayed to MFP applications 608 to generate user notifications.

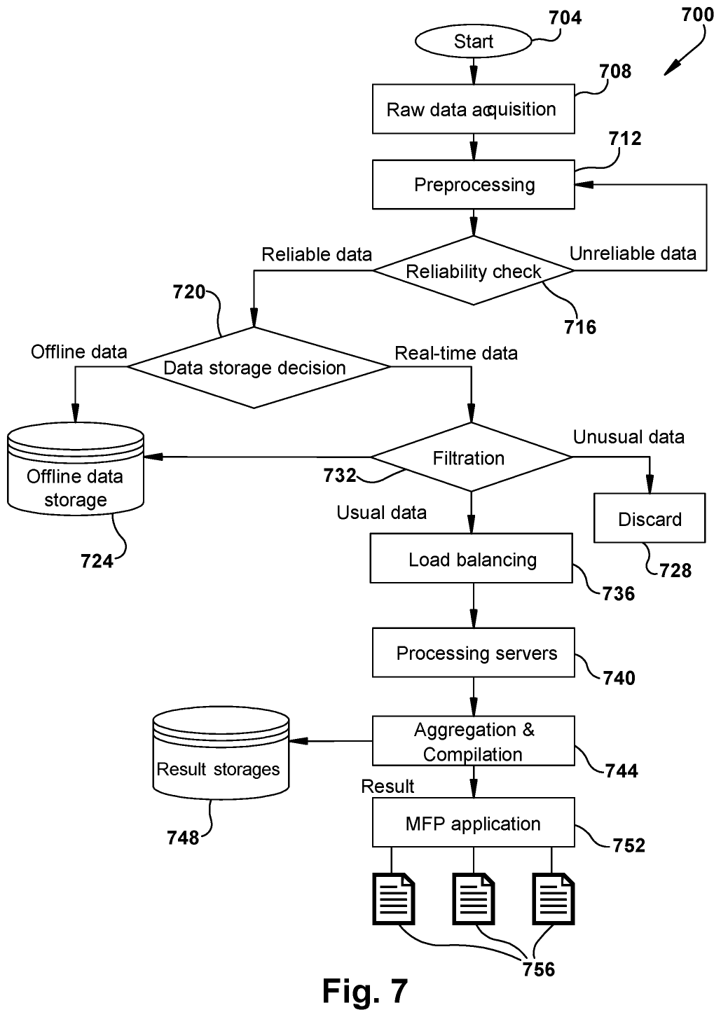

FIG. 7 illustrates flowchart 700 of an example embodiment of a system for printing with improved content. The process commences at block 704 and proceeds to block 708 where raw data, including Internet content and user documents is acquired. Raw data is preprocessed at block 712, and a reliability check of preprocessed data is made at block 716. Unreliable data is returned to block 712 for further preprocessing. A decision is made at block 720 whether data should be stored offline or used in real-time. Offline storage is accomplished at block 724. Real-time data is filtered at block 732. Data determined to be unusual is discarded at block 728. Data determined to be usual is load balanced at block 736 and communicated to one or more processing servers at block 740. Data is aggregated and compiled at block 744 and results are stored at block 748. Results are generated at block 752, leading to one or more suggestions 756.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. A system comprising:
one or more processors and associated data storage;
a printer;
the one or more processors configured to receive an electronic document from an associated user;
the data storage including an analytics dataset;
the one or more processors configured to analyze content of a received electronic document relative to the analytics dataset to extract human characteristics associated with the content;
the one or more processors further configured to generate recommended content in accordance with application of extracted human characteristics to the analytics dataset;
the one or more processors further configured to modify the electronic document to include the recommended content in a modified electronic document; and
the one or more processors further configured to print the modified electronic document via the printer.

2. The system of claim 1 wherein the electronic document is a print document or a scan document.

3. The system of claim 2 wherein the one or more processors is further configured to receive user input relative to the recommended content and update the analytics dataset relative to the user input.

4. The system of claim 3 wherein the one or more processors is further configured to generate or update the analytics dataset in accordance with online search results obtained from one or more servers.

5. The system of claim 4 wherein the online search results include the online search results include free text, characters, images or video data and the one or more processors is further configured to, prior to generating or updating the analytics dataset,
preprocess the online search results prior, and
parse the preprocessed online search results.

6. The system of claim 5 wherein the one or more processors is further configured to perform a reliability check on the parsed preprocessed online search results and generate or update the analytics dataset with parsed preprocessed online search results determined to be reliable by the reliability check.

7. The system of claim 1 wherein the one or more processors is further configured to generate modified text or characters by rewriting or rephrasing text or characters retrieved from the analytics dataset prior to printing.

8. A method comprising:
receiving, into memory, an electronic document from an associated user;
analyzing content of a received electronic document relative to a stored analytics dataset to extract human characteristics associated with the received electronic document;
generating recommended content in accordance with application of extracted human characteristics to the stored analytics dataset;
modifying the electronic document to include the recommended content in a modified electronic document; and
printing the modified electronic document via a printer.

9. The method of claim 8 wherein the electronic document is a print document or a scan document.

10. The method of claim 9 further comprising receiving user input relative to the recommended content and updating the stored analytics dataset relative to the user input.

11. The method of claim 10 further comprising generating or updating the stored analytics dataset in accordance with online search results obtained from one or more servers.

12. The method of claim 11 wherein the online search results include the online search results include text, characters, images, sound or video data and, prior to generating or updating the stored analytics dataset,
preprocessing the online search results prior, and
parsing the preprocessed online search results.

13. The method of claim 12 further comprising performing a reliability check on the parsed preprocessed online search results and generating or updating the stored analytics dataset with parsed preprocessed online search results determined to be reliable by the reliability check.

14. The method of claim 12 rewriting or rephrasing the text or the characters retrieved from the stored analytics dataset prior to printing.

15. A method comprising:
receiving, into memory, an electronic document from an associated user;
analyzing content of a received electronic document relative to a stored analytics dataset to extract human characteristics associated with content of the received electronic document;
generating recommended content in accordance with application of extracted human characteristics to the stored analytics dataset;
showing the recommended content to the associated user;
receiving user input corresponding the recommended content; and
selectively modifying the received electronic document to include some or all of the recommended content in accordance with the user input.

16. The method of claim 15 further comprising printing the selectively modified electronic document.

17. The method of claim 16 further comprising showing the recommended content with a printout of the electronic document or on a display.

18. The method of claim 17 further comprising updating the stored analytics dataset in accordance with the user input.

19. The method of claim 18 further comprising generating the recommended content by rewriting or rephrasing text or character data from the stored analytics dataset.

20. The method of claim 15 wherein the human characteristics comprise one or more of demographics of the associated user or observed behavior.
